(19) United States
(12) Patent Application Publication
(10) Pub. No.: US 2024/0261724 A1
(43) Pub. Date: Aug. 8, 2024

(54) GAS RECOVERY SYSTEM

(71) Applicant: DENSO CORPORATION, Kariya-City (JP)

(72) Inventor: Yuta NISHIWAKI, Kariya-City (JP)

(21) Appl. No.: 18/608,462

(22) Filed: Mar. 18, 2024

Related U.S. Application Data
(63) Continuation of application No. PCT/JP2022/033873, filed on Sep. 9, 2022.

(30) Foreign Application Priority Data
Sep. 24, 2021 (JP) 2021-155297

(51) Int. Cl. B01D 53/32; B01D 53/04

(52) U.S. Cl. CPC B01D 53/326; B01D 53/0407; B01D 2253/202; B01D 2257/504; B01D 2259/812

(57) ABSTRACT

A gas recovery system, which recovers a gas to be recovered from a mixed gas by an electrochemical reaction, includes a plurality of electrochemical cells each having a working electrode and a counter electrode. The plurality of electrochemical cells are stacked, and a gas flow path through which the mixed gas flows is provided between the adjacent electrochemical cells. A support part is disposed between the adjacent electrochemical cells. A predetermined gap is provided between the adjacent electrochemical cells by the support part to form the gas flow path.

### CROSS REFERENCE TO RELATED APPLICATION

The present application is a continuation application of International Patent Application No. PCT/JP2022/033873 filed on Sep. 9, 2022, which designated the U.S. and claims the benefit of priority from Japanese Patent Application No. 2021-155297 filed on Sep. 24, 2021. The entire disclosures of all of the above applications are incorporated herein by reference.

### TECHNICAL FIELD

The present disclosure relates to a gas recovery system that recovers a specific type of gas from a mixed gas.

### BACKGROUND

There has been proposed a gas recovery system that recovers CO₂ from a mixed gas containing CO₂ by an electrochemical reaction. In such a gas recovery system, an electrochemical cell having a working electrode and a counter electrode is provided, and adsorption and release of CO₂ can be switched by changing a potential difference between the working electrode and the counter electrode. Also, a plurality of the electrochemical cells are stacked to provide a gas flow path between the stacked electrochemical cells.

### SUMMARY

The present disclosure describes a gas recovery system that recovers a gas to be recovered from a mixed gas by an electrochemical reaction. According to an aspect, the gas recovery system includes a plurality of electrochemical cells each having a working electrode and a counter electrode, and are stacked so that a gas flow path through which the mixed gas flows is provided between the adjacent electrochemical cells. At least one of the electrochemical cells has a support part that provides a predetermined gap between the adjacent electrochemical cells to provide the gas flow path.

### BRIEF DESCRIPTION OF DRAWINGS

FIG. 1 is a conceptual diagram showing an overall configuration of a carbon dioxide recovery system according to a first embodiment.

FIG. 2 is a perspective view of a CO₂ recovery device.

FIG. 3 is a perspective view showing a state in which a plurality of electrochemical cells are stacked.

FIG. 4 is a perspective view of the electrochemical cell.

FIG. 5 is a perspective view of the electrochemical cell provided with a support part according to the first embodiment.

FIG. 6 is a perspective view showing a state in which the electrochemical cells provided with the support parts are stacked according to the first embodiment.

FIG. 7 is a side view of the electrochemical cell according to the first embodiment.

FIG. 8 is a partial side view showing a modification of an inlet-side support portion according to the first embodiment.

FIG. 9 is a perspective view of an electrochemical cell provided with a support part according to a second embodiment.

FIG. 10 is a perspective view showing a state in which the electrochemical cells provided with the support parts are stacked according to the second embodiment.

FIG. 11 is a perspective view of an electrochemical cell provided with a support part according to a third embodiment.

FIG. 12 is a perspective view showing the support part according to the third embodiment.

FIG. 13 is a perspective view showing a modification of the support part according to the third embodiment.

FIG. 14 is a perspective view showing a modification of the support part according to the third embodiment.

### DETAILED DESCRIPTION

In a gas recovery system in which a plurality of electrochemical cells are used in a stacked state, it is conceivable to narrow a space between the stacked electrochemical cells in order to reduce the size. However, it is difficult to maintain a flow path width of the gas flow path. For this reason, in the electrochemical cells, there is a concern that an increase in pressure loss in a gas introducing section or a variation in the width of the gas flow path may occur.

In addition, in a case where the electrochemical cells contain a liquid material (for example, a CO₂ adsorbent, an electrolyte, or the like), there is a concern that the liquid material may leak due to its own weight or the like when the electrochemical cells are stacked, and gas recovery performance may deteriorate.

The present disclosure provides a technique of maintaining the width of a gas flow path in a gas recovery system that includes a plurality of stacked electrochemical cells and forming the gas flow path between the adjacent electrochemical cells. The present disclosure also provides a technique of suppressing leakage of a liquid material when the electrochemical cells contain a liquid material and are stacked.

According to an aspect of the present disclosure, a gas recovery system includes a plurality of electrochemical cells each having a working electrode and a counter electrode. The electrochemical cells are stacked, and a gas flow path through which a mixed gas flows is formed between the adjacent electrochemical cells. A support part is provided between the adjacent electrochemical cells. A predetermined gap is provided between the adjacent electrochemical cells by the support part. The gap provides the gas flow path.

In such a configuration, since the gap is formed between the adjacent electrochemical cells by the support part, it is possible to maintain a constant space between the adjacent electrochemical cells. Therefore, in the electrochemical cells, it is possible to suppress the increase in pressure loss and the variation in the width of the gas flow path.

The following will describe embodiments for carrying out the present disclosure with reference to the drawings. In the description of each embodiment, parts corresponding to the matters described in its preceding embodiment(s) will be denoted by the same reference numbers as in the preceding embodiment(s), and duplication of description will be omitted as appropriate. When only a part of a configuration is described in an embodiment, another preceding embodiment may be applied to the other parts of the configuration. The present disclosure is not limited to combinations that are explicitly described as being combinable in the description of an embodiment. As long as no problem is present, the embodiments may be partially combined with each other even if not explicitly described.

### First Embodiment

The following describes a first embodiment of the present disclosure with reference to the drawings. In the present embodiment, a gas recovery system of the present disclosure is applied to a carbon dioxide recovery system 1 that recovers CO₂ from a mixed gas. That is, the gas to be recovered as a recovery target of the gas recovery system is CO₂ contained in the mixed gas.

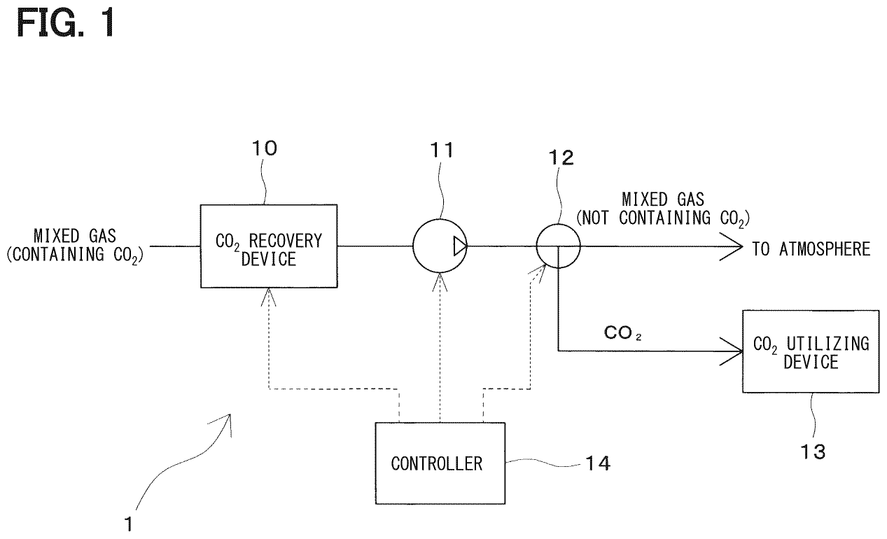

As shown in FIG. 1, a carbon dioxide recovery system 1 of the present embodiment includes a CO₂ recovery device 10, a pump 11, a flow path switching valve 12, a CO₂ utilizing device 13, and a controller 14. In FIG. 1, the mixed gas flows from left to right in the drawing.

The CO₂recovery device 10 is a device that separates and recovers CO₂ from the mixed gas. The mixed gas is a CO₂-containing gas containing CO₂, and for example, atmospheric air or exhaust gas of an internal combustion engine can be used. The mixed gas also contains a gas other than CO₂. The CO₂ recovery device 10 is supplied with the mixed gas containing CO₂ and discharges the mixed gas from which CO₂has been removed or CO₂ recovered from the mixed gas. The configuration of the CO₂ recovery device 10 will be described later in detail.

The pump 11 causes to supply the mixed gas containing CO₂to the CO₂ recovery device 10, and to discharge the mixed gas from which CO₂ has been recovered from the CO₂ recovery device 10. In the example shown in FIG. 1, the pump 11 is provided on the downstream side of the CO₂ recovery device 10 in the gas flow direction. Alternatively, the pump 11 maybe provided on the upstream side of the CO₂ recovery device 10 in the gas flow direction.

The flow path switching valve 12 is a three-way valve that switches the flow path of the exhaust gas of the CO₂ recovery device 10. The flow path switching valve 12 switches the flow path of the exhaust gas to the atmosphere side to discharge the mixed gas from which CO₂has been recovered from the CO₂ recovery device 10, and switches the flow path of the exhaust gas to the CO₂ utilizing device 13 side to discharge CO₂from the CO₂ recovery device 10.

The CO₂ utilizing device 13 is a device that utilizes CO₂. The CO₂ utilizing device 13 maybe a storage tank for storing CO₂ or a conversion device for converting CO₂into fuel. As the conversion device, a device that converts CO₂ into a hydrocarbon fuel such as methane can be used. The hydrocarbon fuel may be gaseous fuel at normal temperature and normal pressure, or may be liquid fuel at normal temperature and normal pressure.

The controller 14 includes a well-known microcontroller including a CPU, a ROM, a RAM and the like, and peripheral circuits thereof. The controller 14 performs various calculations and processes based on control programs stored in the ROM, and controls operations of various devices to be controlled. The controller 14 of the present embodiment performs operation control of the CO₂ recovery device 10, operation control of the pump 11, flow path switching control of the flow path switching valve 12, and the like.

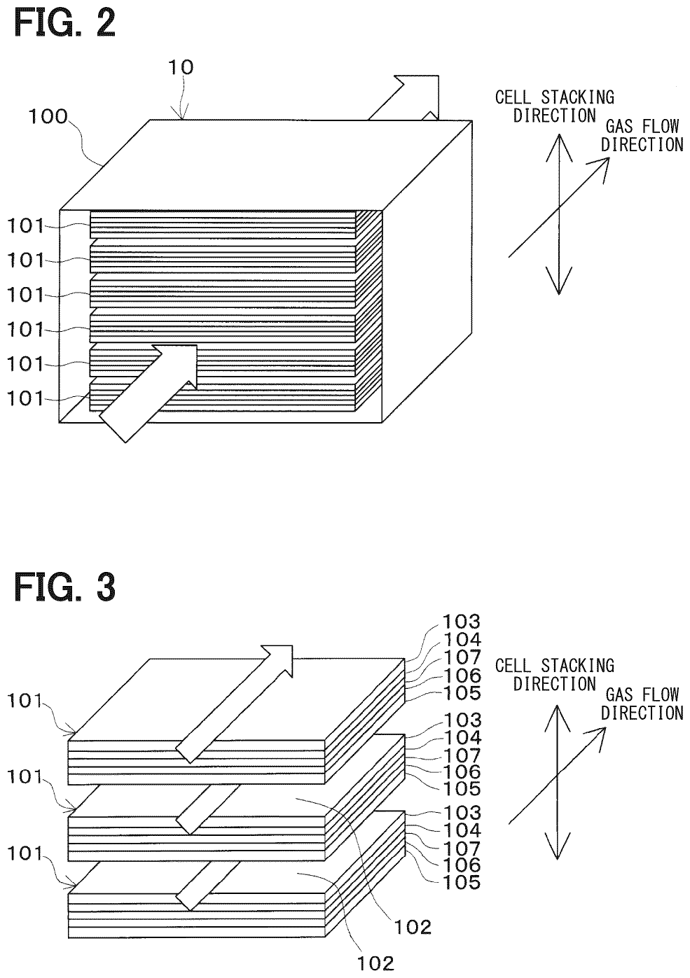

Next, the CO₂ recovery device 10 will be described with reference to FIGS. 2 to 6. In FIGS. 2 to 6, the direction from the front side to the back side of the paper surface is a gas flow direction, and the vertical direction of the paper surface is a cell stacking direction.

As shown in FIG. 2, the CO₂ recovery device 10 has a housing 100. The housing 100 can be made of, for example, a metal material. The housing 100 houses an electrochemical cell 101 therein. The CO₂ recovery device 10 performs adsorption and desorption of CO₂ by an electrochemical reaction of the electrochemical cell 101, and separates and recovers CO₂ from the mixed gas.

The housing 100 has two opening sections. These two opening sections include a gas inflow section that allows the mixed gas to flow into the inside and a gas outflow section that allows the mixed gas from which CO₂ has been recovered or the CO₂ to flow out from the inside. The gas flow direction is a flow direction when the mixed gas passes through the housing 100, and is a direction from the gas inflow section toward the gas outflow section of the housing 100.

In FIG. 2, the mixed gas flows from the front side to the back side of the paper surface. Therefore, the front side of the housing 100 in the drawing is the gas inflow section through which the mixed gas flows into the inside and the back side of the housing in the drawing is the gas outflow section from which the mixed gas flows out from the inside. The housing 100 may be provided with opening and closing members for opening and closing the gas inflow section and the gas outflow section, respectively.

As shown in FIG. 2, a plurality of the electrochemical cells 101 are stacked in the housing 100. The cell stacking direction in which the plurality of electrochemical cells 101 are stacked is orthogonal to the gas flow direction. Each of the electrochemical cells 101 is formed in a plate shape, and is disposed such that the plate surface intersects the cell stacking direction.

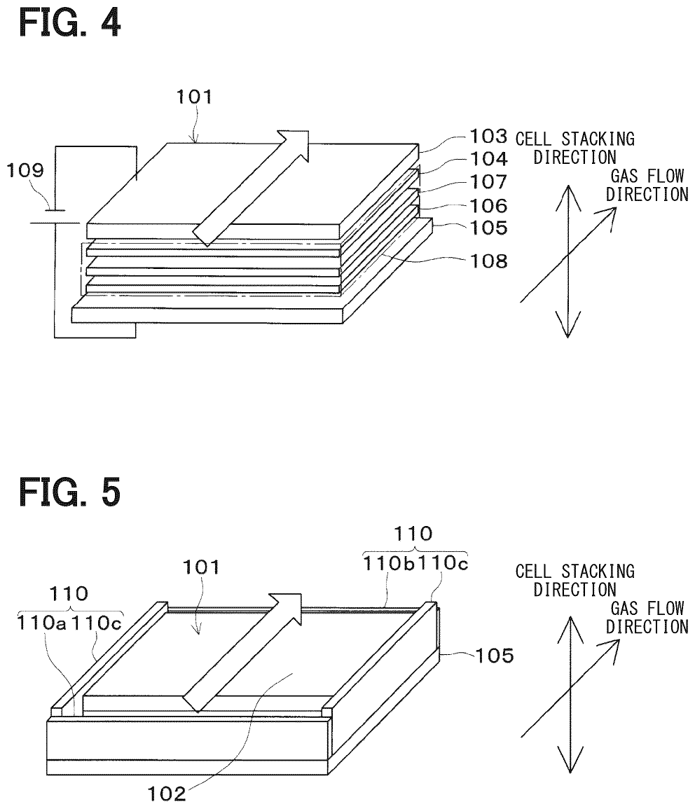

FIG. 3 shows a state in which the plurality of electrochemical cells 101 are stacked. FIG. 4 shows one electrochemical cell 101. In FIG. 4, the components of the electrochemical cell 101, such as a working electrode collector layer 103, are illustrated at intervals, but the components are actually stacked and disposed so as to be in contact with each other. In FIGS. 3 and 4, illustration of a support part 110, which will be described later, is omitted.

As shown in FIG. 3, a predetermined gap is provided between the adjacent electrochemical cells 101. The gap provided between the adjacent electrochemical cells 101 provides a gas flow path 102 through which the mixed gas flows.

As shown in FIGS. 3 and 4, the electrochemical cell 101 includes the working electrode collector layer 103, a working electrode 104, a counter electrode collector layer 105, a counter electrode 106, and a separator 107. Between the adjacent electrochemical cells 101, the working electrode collector layer 103 of one electrochemical cell 101 faces the counter electrode collector layer 105 of the other electrochemical cell 101 across the gas flow path 102. As shown in FIG. 4, in the electrochemical cell 101, an electrolyte 108 is provided over the working electrode 104, the counter electrode 106, and the separator 107.

The working electrode collector layer 103, the working electrode 104, the counter electrode collector layer 105, the counter electrode 106, and the separator 107 are each formed in a plate shape. The electrochemical cell 101 is configured as a stacked body in which the working electrode collector layer 103, the working electrode 104, the counter electrode collector layer 105, the counter electrode 106, and the separator 107 are stacked on top of the other. The direction in which the working electrode collector layer 103 and the like of the individual electrochemical cell 101 are stacked coincides with the cell stacking direction in which the plurality of electrochemical cells 101 are stacked.

The working electrode collector layer 103 is made of a porous conductive material having pores through which the mixed gas containing CO₂ can pass. The working electrode collector layer 103 may have gas permeability and electrical conductivity, and for example, a metal material or a carbonaceous material can be used. In the present embodiment, a metal porous body is used as the working electrode collector layer 103.

The working electrode 104 contains a CO₂ adsorbent, a conductive substance, and a binder. The CO₂ adsorbent, the conductive substance, and the binder are used in the form of a mixture.

The CO₂adsorbent adsorbs CO₂ by receiving electrons and desorbs the adsorbed CO₂by releasing the electrons. As the CO₂ adsorbent, for example, polyanthraquinone can be used.

The conductive substance forms a conductive path to the CO₂ adsorbent. As the conductive substance, for example, a carbon material, such as a carbon nanotube, carbon black, or graphene, can be used.

The binder is provided in order to hold the CO₂ adsorbent and the conductive substance. As the binder, for example, a conductive resin can be used. As the conductive resin, for example, a fluoropolymer or an epoxy resin, which contains Ag or the like as a conductive filler, can be used. Examples of the fluoropolymer includes polytetrafluoroethylene (PTFE) and polyvinylidene fluoride (PVDF).

The counter electrode collector layer 105 is made of a conductive material. As the counter electrode collector layer 105, for example, a metal material or a carbonaceous material can be used. In the present embodiment, a metal plate is used as the counter electrode collector layer 105.

The counter electrode 106 contains an electroactive auxiliary material, a conductive substance, and a binder. Since the conductive substance and the binder of the counter electrode 106 have the same configuration as those of the working electrode 104, the description thereof will be omitted.

The electroactive auxiliary material of the counter electrode 106 is an auxiliary electroactive species that exchanges electrons with the CO₂ adsorbent of the working electrode 104. As the electroactive auxiliary material, for example, a metal complex capable of exchanging electrons by changing the valence of a metal ion can be used. Examples of such metal complex include cyclopentadienyl metal complexes such as ferrocene, nickelocene and cobaltocene, and porphyrin metal complexes. These metal complexes may be polymers or monomers.

The separator 107 is disposed between the working electrode 104 and the counter electrode 106, and separates the working electrode 104 and the counter electrode 106. The separator 107 is an insulating ion-permeable membrane that prevents physical contact between the working electrode 104 and the counter electrode 106 to suppress an electrical short circuit and allows ions to pass therethrough. As the separator 107, a cellulose film, a polymer, a composite material of a polymer and a ceramic, or the like can be used.

As the electrolyte 108, for example, an ionic liquid can be suitably used. The ionic liquid is a salt of a liquid having non-volatility under normal temperature and normal pressure.

As shown in FIG. 4, the electrochemical cell 101 is provided with a power supply 109 that is connected to the working electrode collector layer 103 and the counter electrode collector layer 105. The power supply 109 can apply a predetermined voltage to the working electrode 104 and the counter electrode 106 to change the potential difference between the working electrode 104 and the counter electrode 106. The working electrode 104 is a negative electrode, and the counter electrode 106 is a positive electrode.

By changing the potential difference between the working electrode 104 and the counter electrode 106, the electrochemical cell 101 can be switched between a CO₂ recovery mode in which CO₂ is recovered at the working electrode 104 and a CO₂ release mode in which CO₂ is released from the working electrode 104, and operated in the CO₂recovery mode or the CO₂release mode. The CO₂ recovery mode is a charging mode in which the electrochemical cell 101 is charged, and the CO₂ release mode is a discharging mode in which the electrochemical cell 101 is discharged.

In the CO₂ recovery mode, the first voltage V1 is applied between the working electrode 104 and the counter electrode 106, and electrons are supplied from the counter electrode 106 to the working electrode 104. At the first voltage V1, the working electrode potential is smaller than the counter electrode potential. The first voltage V1 may fall within a range from 0.5 to 2.0 V.

In the CO₂ release mode, the second voltage V2 is applied between the working electrode 104 and the counter electrode 106, and the electrons are supplied from the working electrode 104 to the counter electrode 106. The second voltage V2 is different from the first voltage V1. The second voltage V2 is a voltage lower than the first voltage V1, and a magnitude relationship between the working electrode potential and the counter electrode potential is not limited. That is, in the CO₂ release mode, the working electrode potential may be lower than, equal to, or greater than the counter electrode potential.

As shown in FIG. 5, the electrochemical cell 101 is provided with an insulating support part 110. The support part 110 is provided to form a predetermined gap between the adjacent electrochemical cells 101. The support part 110 is provided for each of the plurality of stacked electrochemical cells 101. The support part 110 may be made of a material having an insulating property and a certain degree of rigidity, and for example, a resin material can be used.

The support part 110 of the present embodiment is a plate-shaped member, and is disposed such that the plate surface is parallel to the cell stacking direction. The support part 110 is provided around the electrochemical cell 101. More specifically, the support part 110 is provided in a loop shape so as to cover the stacking surface of the electrochemical cell 101 as the stacked body. The stacking surface is a surface of the electrochemical cell 101 that can be viewed in a direction orthogonal to the stacking direction of the components of the electrochemical cell 101, and is a surface along which the components of the electrochemical cell 101 appear to overlap. The support part 110 is provided such that the plate surface faces the stacking surface of the electrochemical cell 101. The support part 110 can function as a dam that suppresses leakage of the liquid member contained in the electrochemical cell 101 from the stacking surface by covering the stacking surface of the electrochemical cell 101.

As shown in FIG. 4, the plate surfaces of the working electrode collector layer 103, the working electrode 104, the counter electrode 106, and the separator 107 have the same size when viewed in the cell stacking direction. On the other hand, the counter electrode collector layer 105 has a plate surface larger than that of the working electrode collector layer 103 and the like when viewed in the cell stacking direction. Therefore, when viewed in the cell stacking direction, the counter electrode collector layer 105 has a portion protruding from the working electrode collector layer 103 and the like.

As shown in FIG. 5, the support part 110 is disposed on the plate surface of the counter electrode collector layer 105. More specifically, the support part 110 is disposed at the portion of the counter electrode collector layer 105 protruding from the working electrode collector layer 103 and the like when viewed in the cell stacking direction.

The support part 110 includes one inlet-side support portion 110a, one outlet-side support portion 110b, and two side support portions 110c. The inlet-side support portion 110a and the outlet-side support portion 110b are disposed on opposite sides of the electrochemical cell 101 and arranged in parallel with each other. The two side support portions 110c are disposed on opposite sides of the electrochemical cell 101 and arranged in parallel with each other.

The inlet-side support portion 110a is disposed on the upstream side of the electrochemical cell 101 in the gas flow direction. The outlet-side support portion 110b is disposed on the downstream side of the electrochemical cell 101 in the gas flow direction. The inlet-side support portion 110a and the outlet-side support portion 110b are disposed such that the plate surfaces thereof intersect the gas flow direction. The side support portions 110c are disposed such that the plate surfaces thereof extend along the gas flow direction.

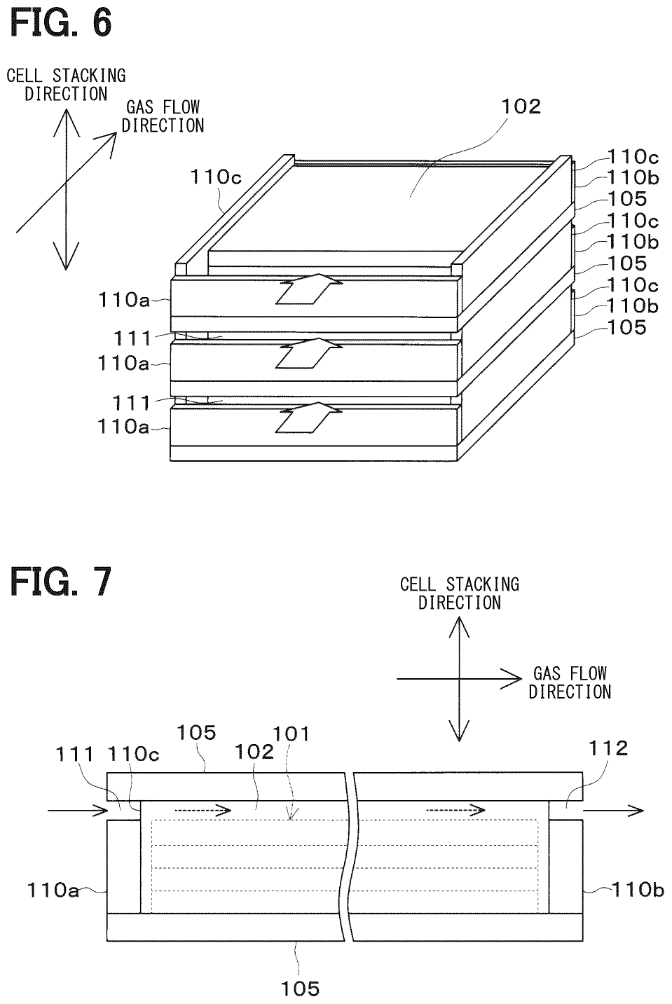

As shown in FIG. 6, the electrochemical cells 101 are stacked in a state where the electrochemical cells 101 are provided with the support parts 110. The side support portions 110c of an electrochemical cell 101 are in contact with the counter electrode collector layer 105 of the adjacent electrochemical cell 101. Therefore, the side support portions 110c of an electrochemical cell 101 are sandwiched between the counter electrode current collector layers 105 of the respectively adjacent electrochemical cells 101. The inlet-side support portion 110a and the outlet-side support portion 110b of an electrochemical cell 101 are not in contact with the counter electrode collector layer 105 of the adjacent electrochemical cell 101.

As shown in FIG. 7, in the cell stacking direction, the height of the side support portion 110c is larger than the height of the electrochemical cell 101 excluding the counter electrode collector layer 105. A predetermined gap is formed between the adjacent electrochemical cells 101 by the side support portions 110c, and the gas flow path 102 is provided by the predetermined gap. Between the two adjacent electrochemical cells 101, the gap formed between the working electrode collector layer 103 of one electrochemical cell 101 and the counter electrode collector layer 105 of the other electrochemical cell 101 is kept constant by the side support portions 110c. Therefore, the width of the gas flow path 102 is secured.

In the cell stacking direction, the height of the side support portion 110c is larger than the heights of the inlet-side support portion 110a and the outlet-side support portion 110b. The inlet-side support portion 110a and the outlet-side support portion 110b are not in contact with the counter electrode collector layer 105 of the adjacent electrochemical cell 101. Therefore, openings are provided between the inlet-side support portion 110a and the outlet-side support portion 110b of the electrochemical cell 101 and the adjacent electrochemical cell 101. The openings serve as a gas flow path inlet 111 through which the mixed gas flows into the gas flow path 102 and a gas flow path outlet 112 through which the mixed gas flows out of the gas flow path 102.

The opening formed between the inlet-side support portion 110a and the adjacent electrochemical cell 101 is the gas flow path inlet 111. The opening formed between the outlet-side support portion 110b and the adjacent electrochemical cell 101 is the gas flow path outlet 112. The mixed gas flowing into the gas flow path 102 from the gas flow path inlet 111 flows toward the downstream side in the gas flow direction and flows out from the gas flow path outlet 112.

Next, an operation of the carbon dioxide recovery system 1 of the present embodiment will be described.

As described above, the carbon dioxide recovery system 1 is operated by alternately switching between the CO₂recovery mode and the CO₂ release mode. The operation of the carbon dioxide recovery system 1 is controlled by the controller 14.

First, the CO₂recovery mode will be described. In the CO₂ recovery mode, the mixed gas containing CO₂is supplied to the CO₂ recovery device 10 by operating the pump 11. In the CO₂ recovery device 10, the voltage applied between the working electrode 104 and the counter electrode 106 of the electrochemical cell 101 is the first voltage V1. With this, it is possible to simultaneously realize electron donation of the electroactive auxiliary material of the counter electrode 106 and electron attraction of the CO₂ adsorbent of the working electrode 104.

The CO₂ adsorbent of the working electrode 104 that has received the electrons from the counter electrode 106 has an increased CO₂ binding force, and binds and adsorbs CO₂contained in the mixed gas. Accordingly, the CO₂ recovery device 10 can recover CO₂ from the mixed gas.

The mixed gas is discharged from the CO₂recovery device 10 after CO₂ is recovered by the CO₂ recovery device 10. The flow path switching valve 12 switches the flow path to the atmosphere side, so that the mixed gas discharged from the CO₂ recovery device 10 is discharged to the atmosphere.

Next, the CO₂release mode will be described. In the CO₂ release mode, the supply of the mixed gas to the CO₂recovery device 10 is stopped. In the CO₂ recovery device 10, the voltage applied between the working electrode 104 and the counter electrode 106 of the electrochemical cell 101 is the second voltage V2. With this, it is possible to simultaneously realize the electron donation of the CO₂ adsorbent of the working electrode 104 and the electron attraction of the electroactive auxiliary material of the counter electrode 106. The CO₂ adsorbent of the working electrode 104 releases the electrons and becomes in an oxidized state. In the CO₂ adsorbent, the binding force of CO₂is reduced, and the CO₂ is desorbed and released.

The CO₂released from the CO₂adsorbent is discharged from the CO₂ recovery device 10. The flow path switching valve 12 switches the flow path to the CO₂utilizing device 13 side, so the CO₂discharged from the CO₂ recovery device 10 is supplied to the CO₂ utilizing device 13.

Prior to the execution of the CO₂release mode, the inside of the CO₂ recovery device 10 maybe vacuumized. By making the CO₂ recovery device 10 in vacuum, the CO₂ can be released in the absence of other gases, and the concentration of recovered CO₂can be increased. The vacuumizing of the CO₂ recovery device 10 maybe realized by performing suction using a vacuum pump in a state where the gas inflow section and the gas outflow section of the housing 100 are closed with the opening and closing members.

According to the present embodiment described above, the electrochemical cells 101 are provided with the support parts 110 having the insulating property, and the gaps are formed between the adjacent electrochemical cells 101 by the support parts 110. Therefore, it is possible to maintain the constant spaces between the adjacent electrochemical cells 101. As such, it is possible to suppress an increase in pressure loss and variations in the width of the gas flow paths in the electrochemical cells 101.

The support part 110 of the present embodiment is provided so as to cover the stacking surface of the electrochemical cell 101. Accordingly, in the case where the electrochemical cell 101 contains a liquid substance, it is possible to suppress leakage of the liquid substance from the stacking surface of the electrochemical cell 101.

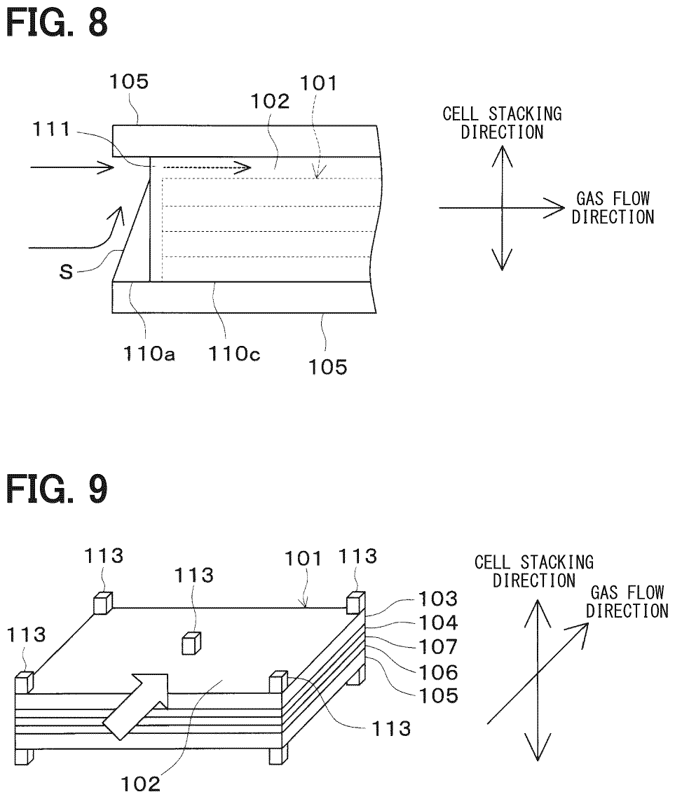

Further, in the present embodiment, the inlet-side support portion 110a may be configured as shown in FIG. 8. FIG. 8 is a side view partially showing the periphery of the gas flow path inlet 111 of the electrochemical cell 101.

In the configuration shown in FIG. 8, the surface of the inlet-side support portion 110a facing the upstream side in the gas flow direction is an inclined surface S that is inclined so that a portion adjacent to the gas flow path inlet 111 is on the downstream side than a portion further from the gas flow path inlet 111. The mixed gas flowing toward the inclined surface S of the inlet-side support portion 110a flows along the face of the inclined surface S and is introduced into the gas flow path inlet 111. Thus, the pressure loss of the mixed gas in the vicinity of the gas flow path inlet 111 can be reduced.

### Second Embodiment

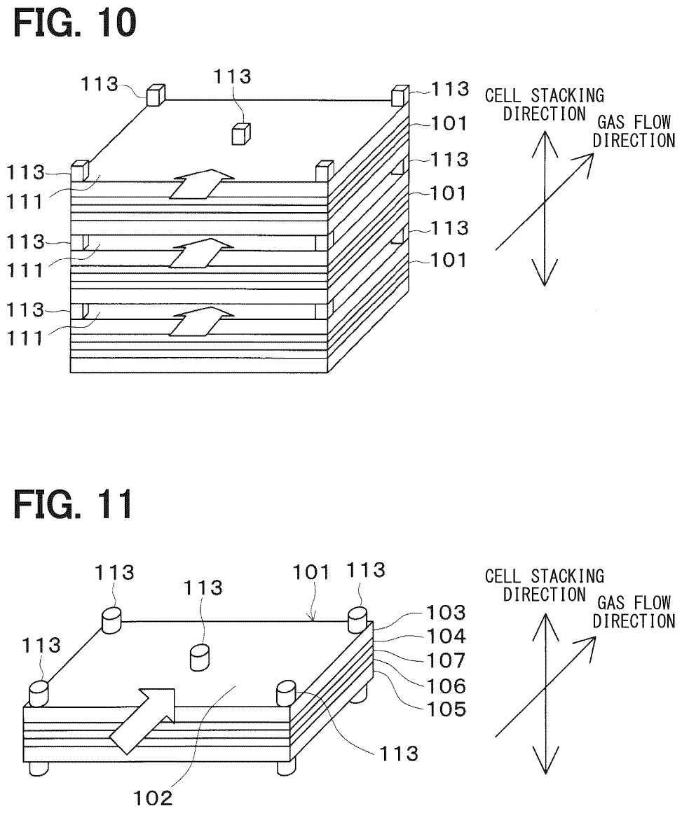

Next, a second embodiment of the present disclosure will be described with reference to FIGS. 9 and 10. Hereinafter, only parts different from the first embodiment will be described.

As shown in FIGS. 9 and 10, in the electrochemical cell 101 of the second embodiment, the plate surface of the counter electrode collector layer 105 has the same size as the plate surfaces of the working electrode collector layer 103 and the like when viewed in the cell stacking direction.

As shown in FIGS. 9 and 10, in the second embodiment, a support part 113 is configured as a columnar member. A plurality of the support parts 113 are provided. The plurality of support parts 113 have at least the same length in the cell stacking direction.

The support parts 113 are disposed between the adjacent electrochemical cells 101 and are in contact with the respective electrochemical cells 101. The support parts 113 are disposed between two adjacent electrochemical cells 101 so as to be interposed between the working electrode collector layer 103 of one electrochemical cell 101 and the counter electrode collector layer 105 of the other electrochemical cell 101.

In the example shown in FIGS. 9 and 10, the support part 113 has a rectangular parallelepiped shape, and has a quadrangular shape as a cross-sectional shape when viewed in the cell stacking direction. In the examples shown in FIGS. 9 and 10, the support parts 113 are disposed at the four corners and near the center of the plate surface of the electrochemical cell 101. However, the number, position, shape, and size of the support parts 113 are not particularly limited.

According to the second embodiment described above, the gaps are formed between the adjacent electrochemical cells 101 by providing the columnar support parts 113 in the electrochemical cells 101. Therefore, it is possible to maintain the constant spaces between the adjacent electrochemical cells 101. As such, it is possible to suppress an increase in pressure loss and variations in the width of the gas flow path in the electrochemical cells 101.

### Third Embodiment

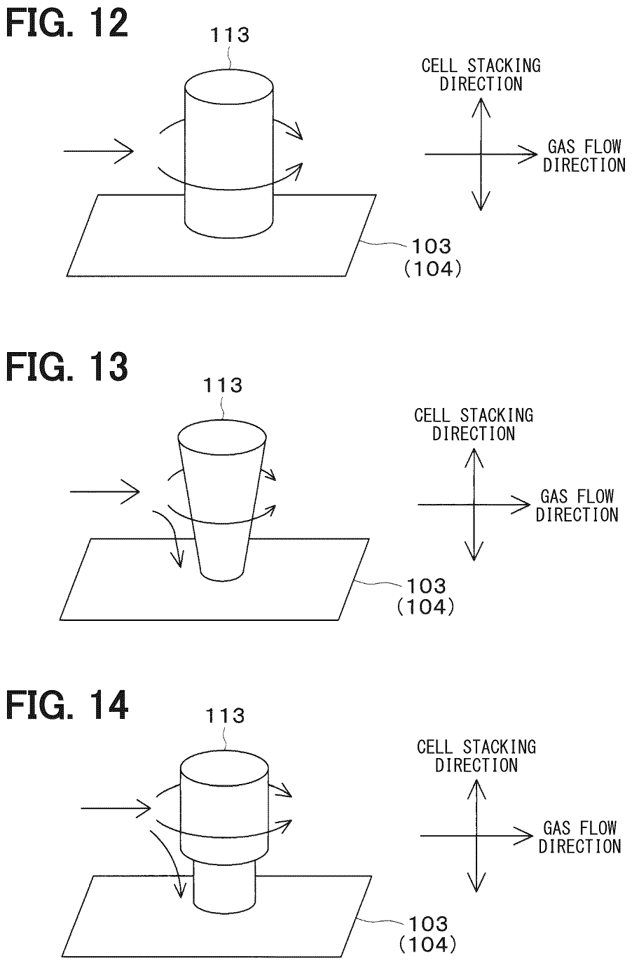

Next, a third embodiment of the present disclosure will be described with reference to FIGS. 11 to 14. Hereinafter, only parts different from the above-described embodiments will be described. Although not shown in FIGS. 12 to 14, the counter electrode collector layer 105 is in contact with the upper end portion of the support part 113 in the drawings.

As shown in FIG. 11, the support part 113 of the third embodiment is formed in a columnar shape. The support part 113 is disposed such that the axial direction of the columnar shape coincides with the cell stacking direction, and has a circular shape as a cross-sectional shape when viewed in the cell stacking direction. That is, the support part 113 has a curved surface protruding toward the upstream side in the gas flow direction at a portion on the upstream side in the gas flow direction.

Therefore, as shown in FIG. 12, the mixed gas flowing toward the support part 113 can flow around the surface of the support part 113 and smoothly flow toward the downstream side in the gas flow direction. Accordingly, the pressure loss of the mixed gas caused by providing the support part 113 in the electrochemical cell 101 can be suppressed as much as possible.

In the third embodiment, the support part 113 may be configured as shown in FIGS. 13 and 14. In the examples shown in FIGS. 13 and 14, the support potion 113 has a circular shape as the cross-sectional shape when viewed in the cell stacking direction. In the example shown in FIG. 13, the support part 113 has a truncated cone shape, and a circular surface having a smaller diameter is in contact with the working electrode collector layer 103. In the example shown in FIG. 14, the support part 113 has a shape in which two columns having different diameters are combined, and a column having a smaller diameter is in contact with the working electrode collector layer 103.

In the examples shown in FIGS. 13 and 14, the cross-sectional area of the support part 113 viewed in the cell stacking direction is smaller at a portion close to the working electrode 104 than at a portion far from the working electrode 104. In the example shown in FIG. 13, the cross-sectional area of the support part 113 when viewed in the cell stacking direction continuously decreases from the portion far from the working electrode 104 toward the portion close to the working electrode 104. In the example shown in FIG. 14, the cross-sectional area of the support part 113 viewed in the cell stacking direction decreases stepwise from the portion far from the working electrode 104 toward the portion close to the working electrode 104.

According to the configurations shown in FIGS. 13 and 14, the mixed gas flowing toward the support part 113 flows around the surface of the support part 113 to the downstream side in the gas flow direction, and at the same time, flows downward in the drawings along the surface of the support part 113. That is, a part of the mixed gas flowing toward the support part 113 flows toward the working electrode collector layer 103. This can promote the incorporation of the mixed gas into the working electrode 104.

The present disclosure is not limited to the embodiments described above, and can be variously modified as follows in a range without departing from the spirit of the present disclosure. The means disclosed in each of the embodiments described above may be appropriately combined to the extent practicable.

For example, in each of the embodiments described above, the example in which the gas recovery system of the present disclosure is applied to the carbon dioxide recovery system 1 that recovers CO₂ from the mixed gas has been described. However, the present disclosure is not limited thereto, and the gas recovery system of the present disclosure can be applied to a configuration in which a specific type of gas other than CO₂ is recovered from a mixed gas.

Although the present disclosure has been described in accordance with the embodiments, it is understood that the present disclosure is not limited to the embodiments described above or structures thereof. The present disclosure is intended to cover various modifications and equivalent arrangements. In addition, while the various elements are shown in various combinations and configurations, which are exemplary, other combinations and configurations, including more, less or only a single element, are also within the spirit and scope of the present disclosure.

What is claimed is:

1. A gas recovery system that recovers a gas to be recovered from a mixed gas by an electrochemical reaction, the gas recovery system comprising:
a plurality of electrochemical cells each having a working electrode and a counter electrode, wherein
when a voltage is applied between the working electrode and the counter electrode, the working electrode adsorbs the gas to be recovered contained in the mixed gas, and
the plurality of electrochemical cells are stacked, and
a gas flow path through which the mixed gas flows is provided between the adjacent electrochemical cells, and
at least one of the electrochemical cells has a support part that provides a predetermined gap between the adjacent electrochemical cells, and
the gap provides the gas flow path through which the mixed gas flows.

2. The gas recovery system according to claim 1, wherein
the support part is a plate member, and
the support part is disposed such that a plate surface of the support part faces a stacking surface of the electrochemical cells and covers a periphery of the stacking surface of the electrochemical cells.

3. The gas recovery system according to claim 2, wherein
a direction connecting a gas flow path inlet of the gas flow path through which the mixed gas flows into the gas flow path and a gas flow path outlet of the gas flow path through which the mixed gas flows out from the gas flow path is defined as a gas flow direction, and
a surface of the support part facing an upstream side in the gas flow direction is an inclined surface that is inclined toward a downstream side in the gas flow direction as approaching the gas flow path inlet.

4. The gas recovery system according to claim 1, wherein
the support part is a columnar member.

5. The gas recovery system according to claim 4, wherein
a direction connecting a gas flow path inlet of the gas flow path through which the mixed gas flows into the gas flow path and a gas flow path outlet of the gas flow path through which the mixed gas flows out from the gas flow path is defined as a gas flow direction, and
the support part has a curved surface protruding toward an upstream side in the gas flow direction.

6. The gas recovery system according to claim 5, wherein
the support part has a columnar shape.

7. The gas recovery system according to claim 4, wherein
the support part is disposed between two adjacent electrochemical cells so as to be interposed between the working electrode of one of the two adjacent electrochemical cells and the counter electrode of the other of the two adjacent electrochemical cells, and
a cross-sectional area of the support part, when viewed in a cell stacking direction in which the plurality of electrochemical cells are stacked, is smaller at a portion closer to the working electrode of the one of the two adjacent electrochemical cells than at a portion further from the working electrode of the one of the two adjacent electrochemical cells.

8. The gas recovery system according to claim 1, wherein
the gas to be recovered is CO₂.
